(19) United States
(12) Patent Application Publication
(10) Pub. No.: US 2022/0044887 A1
(43) Pub. Date: Feb. 10, 2022

(54) KEYSWITCH DEVICE

(71) Applicant: Chicony Electronics Co., Ltd., New Taipei City (TW)

(72) Inventors: Chao-Chin HSIEH, New Taipei City (TW); Chun-Chieh CHAN, New Taipei City (TW); Ping-Chen LI, New Taipei City (TW)

(21) Appl. No.: 17/203,727

(22) Filed: Mar. 16, 2021

(30) Foreign Application Priority Data
Aug. 5, 2020 (TW) 109126576

(51) Int. Cl. H01H 13/70

(52) U.S. Cl. CPC H01H 13/70; H01H 2233/07

(57) ABSTRACT

A keyswitch device includes a connecting member and a keycap. The connecting member has an engaging shaft. The keycap includes a pressing body and a shaft hole structure. The pressing body has a bottom surface. The shaft hole structure is connected to the bottom surface and has an engaging trough and an inlet passage communicated with each other. The engaging shaft is rotatably engaged in the engaging trough. The inlet passage has a first inner wall and a second inner wall opposite and parallel to each other. The first inner wall and the second inner wall are inclined relative to the bottom surface of the pressing body.

### CROSS-REFERENCE TO RELATED APPLICATION

This application claims priority to Taiwan Application Serial Number 109126576, filed Aug. 5, 2020, which is herein incorporated by reference.

### BACKGROUND

### Technical Field

The present disclosure relates to a keyswitch device.

### Description of Related Art

Currently, the keyboard is one of the indispensable input devices to enter text or numbers while using a personal computer (PC). Moreover, consumer electronic products used in daily life or large-scale processing equipment used in the industrial sector require keyswitches as input devices to be operated.

Keycaps of a keyboard generally use narrow-mouth structures (for example, water drop holes) to connect with connection structures below. However, in the keycap pull test, there is often a problem of insufficient tensile strength causing the keycaps to fall off.

Accordingly, how to provide a keyswitch device to solve the aforementioned problems becomes an important issue to be solved by those in the industry.

### SUMMARY

An aspect of the disclosure is to provide a keyswitch device that can efficiently solve the aforementioned problems.

According to an embodiment of the disclosure, a keyswitch device includes a connecting member and a keycap. The connecting member has an engaging shaft. The keycap includes a pressing body and a shaft hole structure. The pressing body has a bottom surface. The shaft hole structure is connected to the bottom surface and has an engaging trough and an inlet passage communicated with each other. The engaging shaft is rotatably engaged in the engaging trough. The inlet passage has a first inner wall and a second inner wall opposite and parallel to each other. The first inner wall and the second inner wall are inclined relative to the bottom surface of the pressing body.

In an embodiment of the disclosure, the engaging shaft has a central axis. An imaginary line extending along a radial direction perpendicular to the central axis is equally spaced between the first inner wall and the second inner wall.

In an embodiment of the disclosure, the shaft hole structure includes at least one first side engaging block and at least one second side engaging block. The at least one first side engaging block forms one part of the engaging trough and has the first inner wall. The at least one second side engaging block forms another part of the engaging trough and has the second inner wall. The at least one first side engaging block and the at least one second side engaging block are connected to the bottom surface and spaced apart from each other.

In an embodiment of the disclosure, the at least one first side engaging block and the at least one second side engaging block respectively has a first engaging wall and a second engaging wall. The first engaging wall and the second engaging wall are respectively connected to the first inner wall and the second inner wall and configured to be engaged with the engaging shaft. The engaging trough is formed at least by the first engaging wall and the second engaging wall.

In an embodiment of the disclosure, at least one part of one the first engaging wall and the second engaging wall is a straight wall.

In an embodiment of the disclosure, the straight wall is perpendicular to the bottom surface of the pressing body.

In an embodiment of the disclosure, the straight wall is inclined relative to the bottom surface of the pressing body.

In an embodiment of the disclosure, the first engaging wall is an arcuate wall.

In an embodiment of the disclosure, the shaft hole structure includes a first bottom surface and a second bottom surface. A height of the first bottom surface relative to the bottom surface of the pressing body is greater than a height of the second bottom surface relative to the bottom surface of the pressing body.

In an embodiment of the disclosure, the first inner wall is closer to a center of the pressing body than the second inner wall. The first inner wall and the second inner wall are inclined away from the center of the pressing body.

In an embodiment of the disclosure, an included angle is formed between a normal line of the bottom surface and the first inner wall. The included angle is 10 to 45 degrees.

In an embodiment of the disclosure, the shaft hole structure further includes a chamfer. The chamfer is connected to an end of the first inner wall away from the engaging trough.

Accordingly, in the keyswitch device of the present disclosure, since the shaft hole structure at the bottom of the keycap has the inclined inlet passage (i.e., the first inner wall and the second inner wall are inclined relative to the bottom surface of the pressing body), the amount of interference in a horizontal direction between the shaft hole structure and the engaging shaft of the connecting member below can be increased during a pull test of the keycap, thereby effectively improving the tensile strength of the keycap. Furthermore, by making the first inner wall and the second inner wall parallel to each other, the structural strength of the shaft hole structure at the inlet passage can be effectively increased, thereby further improving the tensile strength of the keycap.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram showing an assembly stage of a keyswitch device according to an embodiment of the present disclosure;

FIG. 2 is a schematic diagram showing the next assembly stage of the keyswitch device in FIG. 1;

FIG. 3 is a schematic diagram showing the next assembly stage of the keyswitch device in FIG. 2;

FIG. 4 is a schematic diagram showing the next assembly stage of the keyswitch device in FIG. 3;

FIG. 5 is a partial enlarged view of the keyswitch device in FIG. 4;

FIG. 6 is a partial schematic diagram of a keycap according to another embodiment of the present disclosure;

FIG. 7 is a partial schematic diagram of a keycap according to another embodiment of the present disclosure;

FIG. 8 is a partial schematic diagram of a keycap according to another embodiment of the present disclosure;

FIG. 9 is a partial schematic diagram of a keycap according to another embodiment of the present disclosure;

FIG. 10 is a partial perspective view of the keycap in FIG. 7;

FIG. 11 is a partial perspective view of a keycap according to another embodiment of the present disclosure;

FIG. 12 is a partial perspective view of a keycap according to another embodiment of the present disclosure; and

FIG. 13 is a partial perspective view of a keycap according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

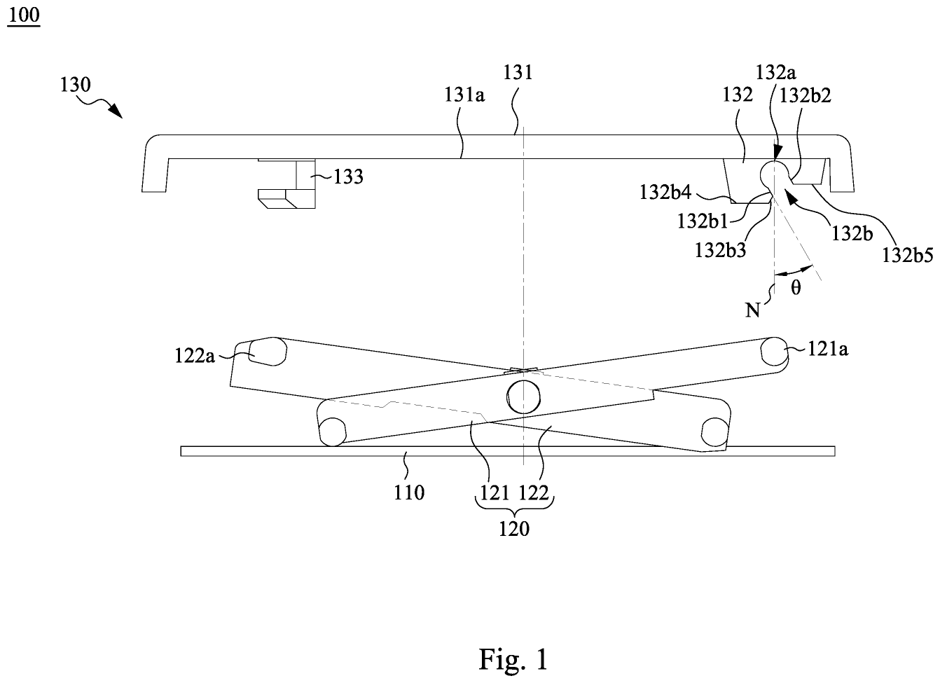

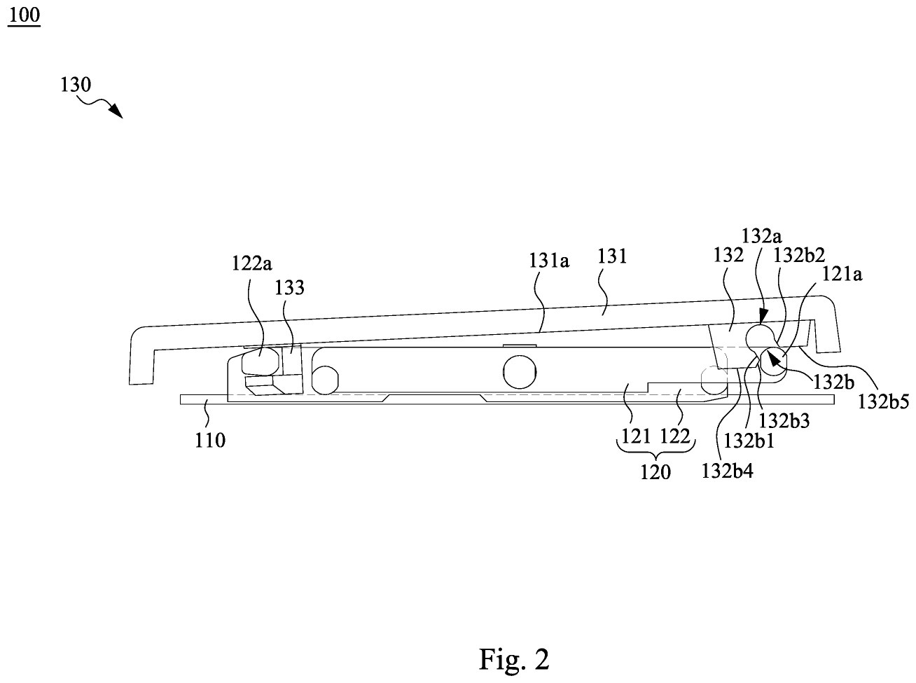

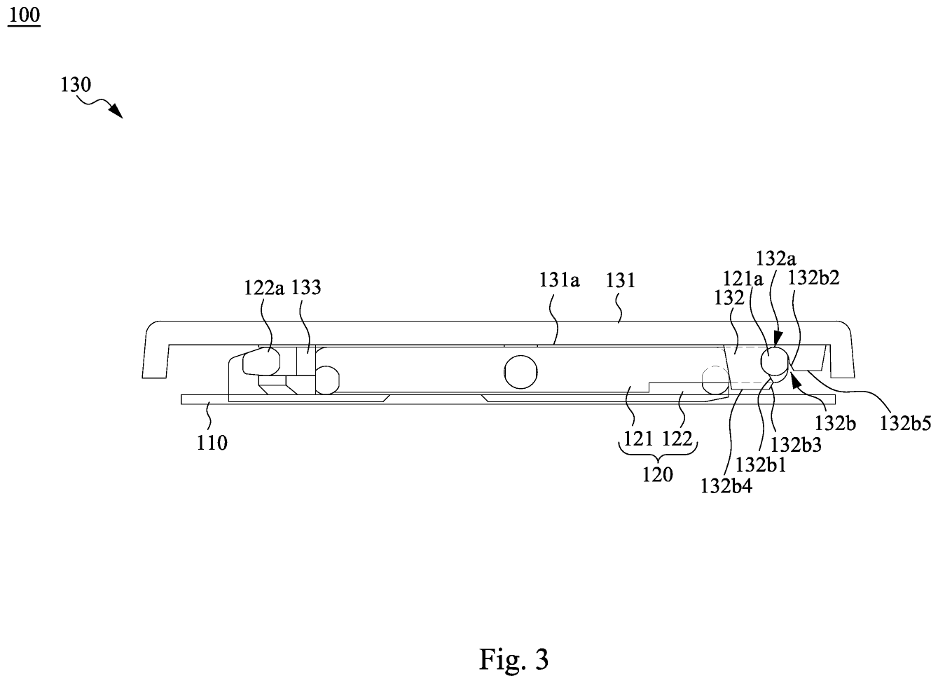

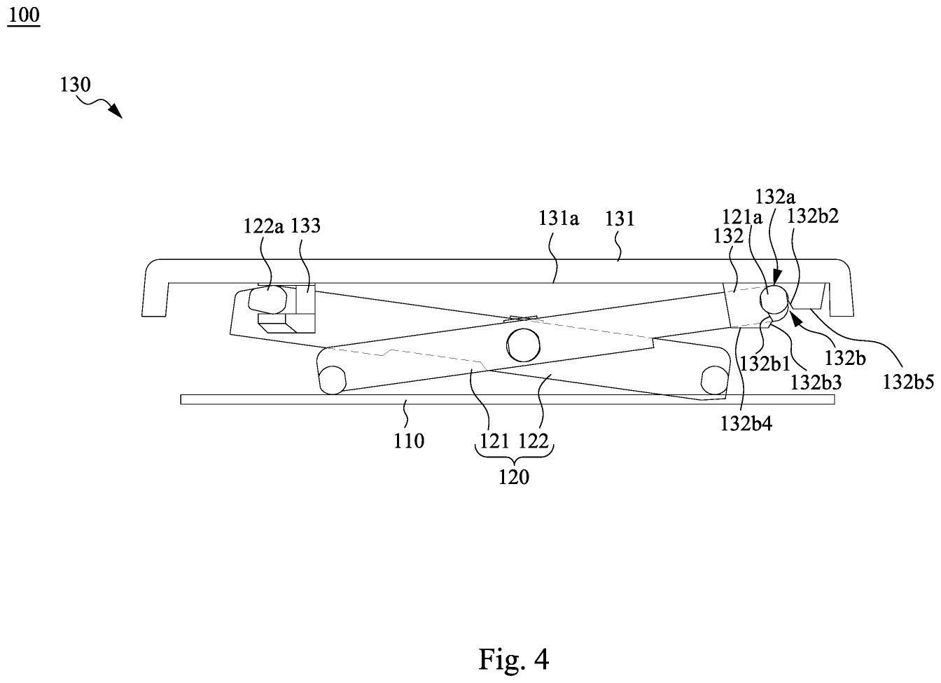

Reference is made to FIGS. 1 to 4. FIG. 1 is a schematic diagram showing an assembly stage of a keyswitch device 100 according to an embodiment of the present disclosure. FIG. 2 is a schematic diagram showing the next assembly stage of the keyswitch device 100 in FIG. 1. FIG. 3 is a schematic diagram showing the next assembly stage of the keyswitch device 100 in FIG. 2. FIG. 4 is a schematic diagram showing the next assembly stage of the keyswitch device 100 in FIG. 3. As shown in FIG. 1, in the present embodiment, the keyswitch device 100 includes a bottom plate 110, a connecting assembly 120, and a keycap 130. The connecting assembly 120 is connected between the bottom plate 110 and the keycap 130, and is configured to move the keycap 130 upward and downward relative to the bottom plate 110. The connecting assembly 120 includes connecting members 121, 122. The connecting member 121 has an engaging shaft 121a for engaging with the keycap 130. The connecting member 122 has a sliding shaft 122a for engaging with the keycap 130. The keycap 130 includes a pressing body 131, a shaft hole structure 132, and a sliding trough structure 133. The pressing body 131 has a bottom surface 131a. The shaft hole structure 132 and the sliding trough structure 133 are connected to the bottom surface 131a. The shaft hole structure 132 has an engaging trough 132a and an inlet passage 132b communicated with each other. The engaging shaft 121a is rotatably engaged with the engaging trough 132a. The sliding shaft 122a is slidably engaged with the sliding trough structure 133.

When assembling, the keycap 130 can be moved obliquely to engage the sliding trough structure 133 with the sliding shaft 122a, as shown in FIG. 2. At this time, the inlet passage 132b of the shaft hole structure 132 just abuts against the engaging shaft 121a of the connecting member 121. Then, the keycap 130 is pressed down such that the engaging shaft 121a of the connecting member 121 is engaged with the engaging trough 132a through the inlet passage 132b, as shown in FIG. 3. Finally, the keyswitch device 100 may further include a position-returning member (not shown, such as a rubber dome) disposed between the bottom plate 110 and the keycap 130, and the position-returning member can lift the keycap 130 to the unpressed position (i.e., the highest position in the stroke of the keycap 130 when the keycap 130 is pressed), as shown in FIG. 4.

In the present embodiment, the connecting assembly 120 uses a scissors-like connecting structure as an embodiment, but the disclosure is not limited in this regard. In practical applications, the connecting assembly 120 may be replaced with other supporting structures with similar functions (that is, moving the keycap 130 upward and downward relative to the bottom plate 110), such as a V-shaped, a A-shaped, or a two-parallel linkage structure.

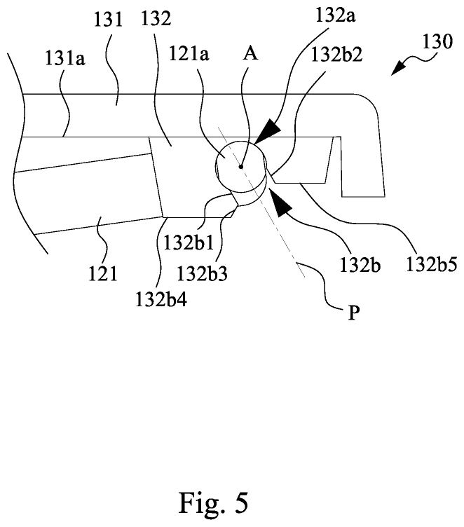

Reference is made to FIG. 5. FIG. 5 is a partial enlarged view of the keyswitch device 100 in FIG. 4. As shown in FIG. 5, in the present embodiment, the inlet passage 132b has a first inner wall 132b1 and a second inner wall 132b2 opposite to each other. The first inner wall 132b1 and the second inner wall 132b2 are inclined relative to the bottom surface 131a of the pressing body 131. With reference to FIG. 2, the first inner wall 132b1 is closer to a center of the pressing body 131 than the second inner wall 132b2. As shown in FIG. 1, an included angle θ is formed between a normal line N of the bottom surface 131a at a center of the engaging trough 132a and the first inner wall 132b1. The first inner wall 132b1 and the second inner wall 132b2 are inclined relative to the normal line N and away from the center of the pressing body 131.

With the foregoing structural configurations, the amount of interference in a horizontal direction between the shaft hole structure 132 and the engaging shaft 121a of the connecting member 121 below can be increased during a pull test of the keycap 130, thereby effectively improving the tensile strength of the keycap 130. In other words, the tensile strength of the keycap 130 can be significantly improved by appropriately adjusting the aforementioned amount of interference.

In some embodiments, the included angle θ is 10 to 45 degrees. When the included angle θ is less than the aforementioned range, the amount of interference in the horizontal direction between the shaft hole structure 132 and the engaging shaft 121a may not be large enough, and the tensile strength of the keycap 130 cannot be effectively improved (i.e., easy to be disassembled). When the included angle θ is greater than the aforementioned range, the inlet passage 132b will be too inclined, which will cause it to be difficult for the engaging shaft 121a to enter the engaging trough 132a through the inlet passage 132b when the keycap 130 is pressed down in the assembly stage shown in FIG. 2 (i.e., difficult to be assembled).

Furthermore, in the present embodiment, the first inner wall 132b1 and the second inner wall 132b2 are parallel to each other. Hence, the structural strength of the shaft hole structure 132 at the inlet passage 132b can be effectively increased, so that the tensile strength of the keycap 130 can be further improved.

As shown in FIG. 5, in the present embodiment, the engaging shaft 121a has a central axis A. An imaginary line P extending along a radial direction perpendicular to the central axis A is equally spaced between the first inner wall 132b1 and the second inner wall 132b2. Hence, when the engaging shaft 121a is pressed into the engaging trough 132a obliquely, the amounts of interference of the first inner wall 132b1 and the second inner wall 132b2 with the engaging shaft 121a are the same, so that the engaging shaft 121a can accurately enter the engaging trough 132a through the inlet passage 132b.

It is clear from the foregoing disclosure that the shaft hole structure 132 having the aforementioned structural configurations has the advantages of being easy to be assembled and difficult to be disassembled with respect to the engaging shaft 121a.

In some embodiments, as shown in FIG. 5, the shaft hole structure 132 further includes a first bottom surface 132b4 and a second bottom surface 132b5. The first bottom surface 132b4 and the second bottom surface 132b5 are respectively connected to the first inner wall 132b1 and the second inner wall 132b2. A height of the first bottom surface 132b4 relative to the bottom surface 131a is greater than a height of the second bottom surface 132b5 relative to the bottom surface 131ay. The height difference between the first bottom surface 132b4 and the second bottom surface 132b5 facilitates the alignment between the engaging shaft 121a and the inlet passage 132b in the assembly stage shown in FIG. 2.

In some embodiments, as shown in FIG. 5, the shaft hole structure 132 further includes a chamfer 132b3. The chamfer 132b3 is connected to an end of the first inner wall 132b1 away from the engaging trough 132a. That is, the chamfer 132b3 is connected between the first inner wall 132b1 and the first bottom surface 132b4. When the keycap 130 is pressed down to move the engaging shaft 121a from the first bottom surface 132b4 to abut against the inlet passage 132b, the chamfer 132b3 can reduce the obstruction of the shaft hole structure 132 to the engaging shaft 121a.

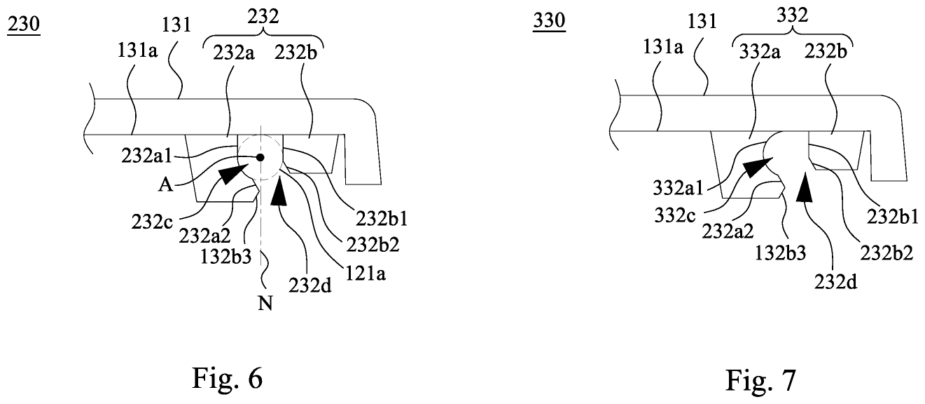

Reference is made to FIG. 6. FIG. 6 is a partial schematic diagram of a keycap 230 according to another embodiment of the present disclosure. As shown in FIG. 6, in the present embodiment, the keycap 230 includes a pressing body 131 and a shaft hole structure 232. The pressing body 131 is identical to that of the embodiment shown in FIG. 5 and will not repeated here for simplicity. The shaft hole structure 232 includes a first side engaging block 232a and a second side engaging block 232b. The first side engaging block 232a forms one part of the engaging trough 232c and has the first inner wall 232a2. The second side engaging block 232b forms another part of the engaging trough 232c and has the second inner wall 232b2. The first side engaging block 232a and the second side engaging block 232b are connected to the bottom surface 131a and spaced apart from each other.

In the embodiment where the keycap 230 is made of plastic through an injection molding process, by designing the shaft hole structure 232 to include the first side engaging block 232a and the second side engaging block 232b that are spaced apart from each other, the problem of material shrinkage at the location of the pressing body 131 of the keycap 230 corresponding to the shaft hole structure 232 can be effectively solved.

As shown in FIG. 6, a height of the first side engaging block 232a relative to the bottom surface 131a is greater than a height of the second side engaging block 232b relative to the bottom surface 131a. The height difference between the first side engaging block 232a and the second side engaging block 232b facilitates the alignment between the engaging shaft 121a and an inlet passage 232d in the assembly stage shown in FIG. 2.

In detail, the first side engaging block 232a and the second side engaging block 232b respectively has a first engaging wall 232a1 and a second engaging wall 232b1. The first engaging wall 232a1 and the second engaging wall 232b1 are respectively connected to the first inner wall 232a2 and the second inner wall 232b2 and configured to be engaged with the engaging shaft 121a. The engaging trough 232c is formed at least by the first engaging wall 232a1 and the second engaging wall 232b1.

In the embodiment as shown in FIG. 6, a part of the first engaging wall 232a1 and the second engaging wall 232b1 are straight walls. These straight walls are perpendicular to the bottom surface 131a of the pressing body 131. The normal line N of the bottom surface 131a at the center of the engaging trough 232c is parallel and equidistantly located between the first engaging wall 232a1 and the second engaging wall 232b1, so that the engaging shaft 121a (indicated by the dotted line in FIG. 6) firmly abuts between the first engaging wall 232a1 and the second engaging wall 232b1 while being engaged in the engaging trough 232c. However, the present disclosure is not limited in this regard.

Reference is made to FIG. 7. FIG. 7 is a partial schematic diagram of a keycap 330 according to another embodiment of the present disclosure. As shown in FIG. 7, in the present embodiment, the keycap 330 includes a pressing body 131 and a shaft hole structure 332. The pressing body 131 is identical to that of the embodiment shown in FIG. 5 and will not repeated here for simplicity. The shaft hole structure 332 includes a first side engaging block 332a and a second side engaging block 232b. The first side engaging block 332a forms one part of the engaging trough 332c and has the first inner wall 232a2. The second side engaging block 232b forms another part of the engaging trough 332c. The first side engaging block 332a and the second side engaging block 232b are connected to the bottom surface 131a and spaced apart from each other. The first side engaging block 332a has a first engaging wall 332a1. The first engaging wall 332a1 is connected to the first inner wall 232a2. It should be noted that, compared with the embodiment shown in FIG. 6, the first engaging wall 332a1 of the present embodiment is an arcuate wall and is configured to fit a part of the surface of the engaging shaft 121a, thereby increasing the contact area.

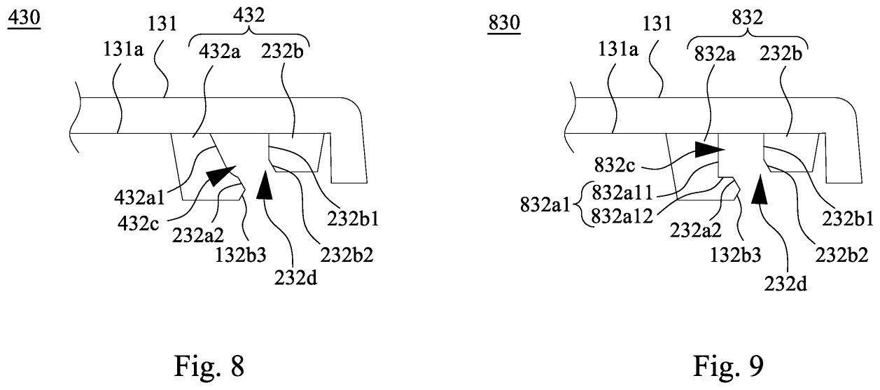

Reference is made to FIG. 8. FIG. 8 is a partial schematic diagram of a keycap 430 according to another embodiment of the present disclosure. As shown in FIG. 8, in the present embodiment, the keycap 430 includes a pressing body 131 and a shaft hole structure 432. The pressing body 131 is identical to that of the embodiment shown in FIG. 5 and will not repeated here for simplicity. The shaft hole structure 432 includes a first side engaging block 432a and a second side engaging block 232b. The first side engaging block 432a forms one part of the engaging trough 432c and has the first inner wall 232a2. The second side engaging block 232b forms another part of the engaging trough 432c. The first side engaging block 432a and the second side engaging block 232b are connected to the bottom surface 131a and spaced apart from each other. The first side engaging block 432a has a first engaging wall 432a1. The first engaging wall 432a1 is connected to the first inner wall 232a2. It should be noted that, compared with the embodiment shown in FIG. 6, the portion that is a straight wall of the first engaging wall 432a1 is inclined relative to the bottom surface 131a of the pressing body 131.

Reference is made to FIG. 9. FIG. 9 is a partial schematic diagram of a keycap 830 according to another embodiment of the present disclosure. As shown in FIG. 9, in the present embodiment, the keycap 830 includes a pressing body 131 and a shaft hole structure 832. The pressing body 131 is identical to that of the embodiment shown in FIG. 5 and will not repeated here for simplicity. The shaft hole structure 832 includes a first side engaging block 832a and a second side engaging block 232b. The first side engaging block 832a forms one part of the engaging trough 832c and has the first inner wall 232a2. The second side engaging block 232b forms another part of the engaging trough 832c. The first side engaging block 832a and the second side engaging block 232b are connected to the bottom surface 131a and spaced apart from each other. The first side engaging block 832a has a first engaging wall 832a1. The first engaging wall 832a1 is connected to the first inner wall 232a2. It should be noted that, compared with the embodiment shown in FIG. 6, the first engaging wall 832a1 of the present embodiment has a first wall portion 832a11 and a second wall portion 832a12 connected to each other. The first wall portion 832a11 is connected between the bottom surface 131a and the second wall portion 832a12. The second wall portion 832a12 is connected between the first wall portion 832a11 and the first inner wall 232a2. Both the first wall portion 832a11 and the second wall portion 832a12 are straight walls and a right angle is formed therebetween.

In the embodiments shown in FIGS. 6 to 9, the wall surface of the engaging walls can include a vertical surface, an arcuate surface, an inclined straight surface, or straight surfaces forming a right angle. The connecting areas between these structures and the bottom surface 131a of the pressing body 131 becomes uniform, so that the surface of the keycap 130 is less prone to surface shrinkage during plastic injection molding, and the structural strength of taper pins of the plastic mold design can also be increased.

In addition, in the embodiments shown in FIGS. 6 to 9, an end of the first inner wall 232a2 away from the engaging troughs 232c, 332c, 432c, 832c can be further connected to the chamfer 132b3 as shown in FIG. 5. When the keycap 130 is pressed down to move the engaging shaft 121a from the first side engaging blocks 232a, 332a, 432a, 832a to abut against the inlet passage 232d, the chamfer 132b3 can reduce the obstruction of the shaft hole structure 132 to the engaging shaft 121a.

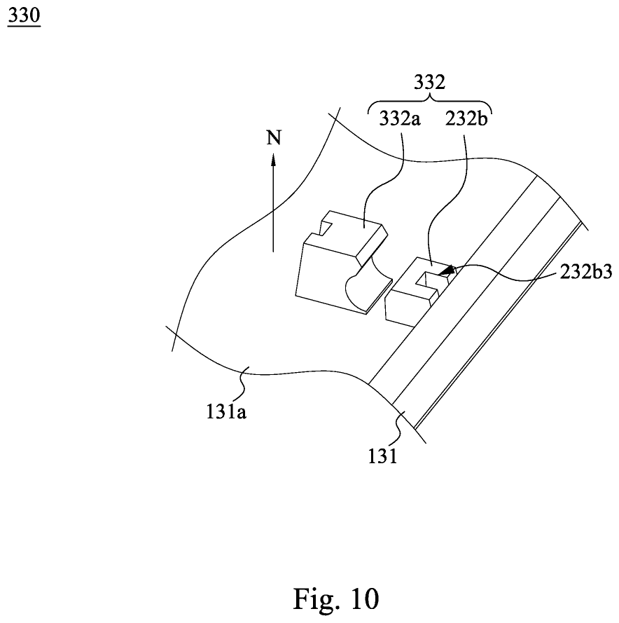

Reference is made to FIG. 10. FIG. 10 is a partial perspective view of the keycap 330 in FIG. 7. As shown in FIG. 10, in the present embodiment, the shaft hole structure 332 only includes one first side engaging block 332a and one second side engaging block 232b. However, the present disclosure is not limited in this regard. Specifically, the second side engaging block 232b has a notch 232b3. The notch 232b3 is located at a side of the second side engaging block 232b away from the first side engaging block 332a and is formed along the normal line N to abut against the bottom surface 131a of the pressing body 131. Hence, the thickness of the second side engaging block 232b is uniform, which helps to reduce the shrinkage of the surface of the keycap 130 during plastic injection molding.

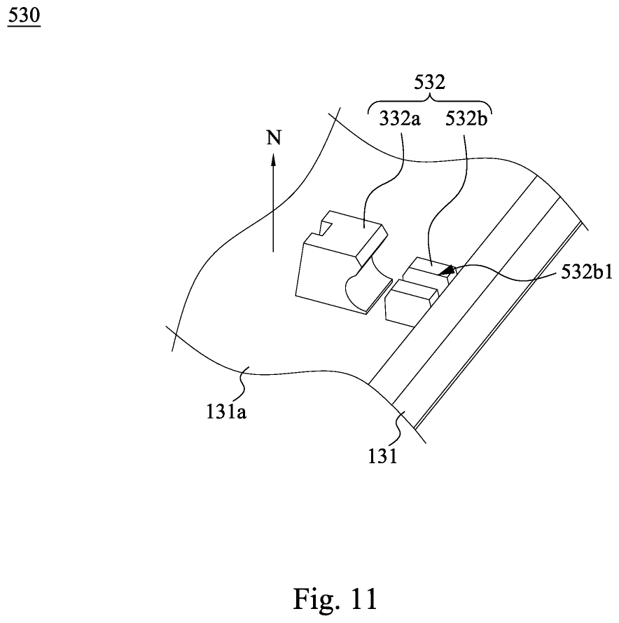

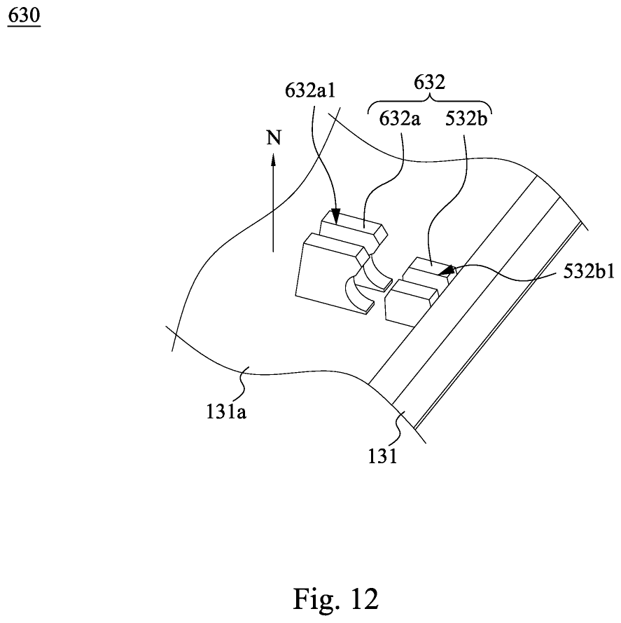

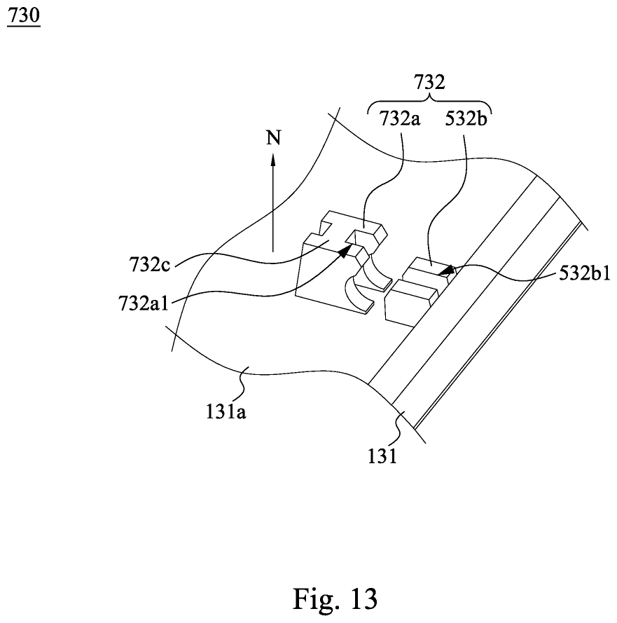

Reference is made to FIG. 11. FIG. 11 is a partial perspective view of a keycap 530 according to another embodiment of the present disclosure. As shown in FIG. 11, in the present embodiment, the shaft hole structure 532 includes one first side engaging block 332a and two second side engaging blocks 532b. By replacing the single second side engaging block 232b shown in FIG. 10 with the two second side engaging blocks 532b of the present embodiment, the problem of material shrinkage at the locations of the pressing body 131 of the keycap 530 corresponding to the second side engaging blocks 532b can be further avoided. Specifically, the two second side engaging blocks 532b have a notch 532b1 therebetween, and the notch 532b1 penetrates from the side of the second side engaging blocks 532b away from the first side engaging block 332a to the side of the second side engaging blocks 532b close to the first side engaging block 332a. Reference is made to FIG. 12. FIG. 12 is a partial perspective view of a keycap 630 according to another embodiment of the present disclosure. As shown in FIG. 12, in the present embodiment, the shaft hole structure 632 includes two first side engaging blocks 632a and two second side engaging blocks 532b. By replacing the single first side engaging block 332a shown in FIG. 11 with the two first side engaging blocks 632a of the present embodiment, the problem of material shrinkage at the locations of the pressing body 131 of the keycap 630 corresponding to the first side engaging blocks 632a can be further avoided. Specifically, the two first side engaging blocks 632a have a notch 632a1 therebetween, and the notch 632a1 penetrates from the side of the first side engaging blocks 632a away from the second side engaging blocks 532b to the side of the first side engaging blocks 632a close to the second side engaging blocks 532b. Reference is made to FIG. 13. FIG. 13 is a partial perspective view of a keycap 730 according to another embodiment of the present disclosure. Compared with the embodiment as shown in FIG. 12, the shaft hole structure 732 of the present embodiment further includes a rib 732c connected between two first side engaging blocks 732a, so as to the entire structural strength of the two first side engaging blocks 732a.

According to the foregoing recitations of the embodiments of the disclosure, it can be seen that in the keyswitch device of the present disclosure, since the shaft hole structure at the bottom of the keycap has the inclined inlet passage (i.e., the first inner wall and the second inner wall are inclined relative to the bottom surface of the pressing body), the amount of interference in a horizontal direction between the shaft hole structure and the engaging shaft of the connecting member below can be increased during a pull test of the keycap, thereby effectively improving the tensile strength of the keycap. Furthermore, by making the first inner wall and the second inner wall parallel to each other, the structural strength of the shaft hole structure at the inlet passage can be effectively increased, thereby further improving the tensile strength of the keycap.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A keyswitch device, comprising:
a connecting member having an engaging shaft; and
a keycap comprising:
a pressing body having a bottom surface; and
a shaft hole structure connected to the bottom surface and having an engaging trough and an inlet passage communicated with each other,
wherein the engaging shaft is rotatably engaged in the engaging trough,
wherein the inlet passage has a first inner wall and a second inner wall opposite and parallel to each other, and the first inner wall and the second inner wall are inclined relative to the bottom surface of the pressing body.

2. The keyswitch device of claim 1, wherein the engaging shaft has a central axis, and an imaginary line extending along a radial direction perpendicular to the central axis is equally spaced between the first inner wall and the second inner wall.

3. The keyswitch device of claim 1, wherein the shaft hole structure comprises:
at least one first side engaging block forming one part of the engaging trough and having the first inner wall; and
at least one second side engaging block forming another part of the engaging trough and having the second inner wall,
wherein the at least one first side engaging block and the at least one second side engaging block are connected to the bottom surface and spaced apart from each other.

4. The keyswitch device of claim 3, wherein the at least one first side engaging block and the at least one second side engaging block respectively has a first engaging wall and a second engaging wall, the first engaging wall and the second engaging wall are respectively connected to the first inner wall and the second inner wall and configured to be engaged with the engaging shaft, and the engaging trough is formed at least by the first engaging wall and the second engaging wall.

5. The keyswitch device of claim 4, wherein at least one part of one the first engaging wall and the second engaging wall is a straight wall.

6. The keyswitch device of claim 5, wherein the straight wall is perpendicular to the bottom surface of the pressing body.

7. The keyswitch device of claim 5, wherein the straight wall is inclined relative to the bottom surface of the pressing body.

8. The keyswitch device of claim 4, wherein the first engaging wall is an arcuate wall.

9. The keyswitch device of claim 3, wherein the shaft hole structure further comprises a chamfer, and the chamfer is connected to an end of the first inner wall away from the engaging trough.

10. The keyswitch device of claim 1, wherein the shaft hole structure comprises a first bottom surface and a second bottom surface, and a height of the first bottom surface relative to the bottom surface of the pressing body is greater than a height of the second bottom surface relative to the bottom surface of the pressing body.

11. The keyswitch device of claim 1, wherein the first inner wall is closer to a center of the pressing body than the second inner wall, and the first inner wall and the second inner wall are inclined away from the center of the pressing body.

12. The keyswitch device of claim 1, wherein an included angle is formed between a normal line of the bottom surface and the first inner wall, and the included angle is 10 to 45 degrees.

13. The keyswitch device of claim 1, wherein the shaft hole structure further comprises a chamfer, and the chamfer is connected to an end of the first inner wall away from the engaging trough.
